(19) United States
(12) Patent Application Publication
(10) Pub. No.: US 2023/0126364 A1
(43) Pub. Date: Apr. 27, 2023

(54) SYSTEMS AND SIGNAL PROCESSING METHODS FOR REAL-TIME TRAFFIC CONGESTION DETECTION

(71) Applicant: UNIVERSITY OF SOUTH FLORIDA, Tampa, FL (US)

(72) Inventors: Vishal Chandra Kummetha, Tampa, FL (US); Mohsen Kamrani, Lutz, FL (US); Sisinnio Concas, Tampa, FL (US)

(21) Appl. No.: 17/971,758

(22) Filed: Oct. 24, 2022

Related U.S. Application Data
(60) Provisional application No. 63/262,935, filed on Oct. 22, 2021.

(51) Int. Cl. G08G 1/01

(52) U.S. Cl. CPC G08G 1/0133; G08G 1/0112

(57) ABSTRACT

A method for traffic congestion detection for a roadway facility having a plurality of segments includes receiving travel time data from at least one travel time data source for a plurality of predetermined time intervals and determining a travel time index (TTI) for each time interval based on the travel time data associated with the time interval. The method further includes determining a change in travel time index (TTI) intensity between two successive time intervals for each pair of successive time intervals in the plurality of time intervals, applying a signal processing filter to the determined change in travel time index intensity to generate a filter value for each time interval; and determining a congestion level for each time interval based on the filter value for each time interval and a predetermined set of congestion level thresholds.

### CROSS-REFERENCE TO RELATED APPLICATIONS

This patent application is based on, claims priority to and incorporates by reference in its entirety U.S. Provisional Patent Application Ser. No. 63/262,935 filed on Oct. 22, 2021, entitled “Real-Time Traffic Congestion Detection Independent of Travel Time Data Source.”

### STATEMENT OF GOVERNMENT SUPPORT

This invention was made with government support under grant/contract number 69A3551947136, awarded by the Department of Transportation. The Government may have certain rights in this invention.

### TECHNICAL FIELD

The technology discussed below relates generally to traffic congestion management, and more particularly, to a system and method for detecting traffic congestion and determining congestion levels using real time travel time data and a signal processing filter.

### BACKGROUND

Traffic congestion is a phenomenon that has been extensively explored by researchers. Congestion can occur when demand (volume of roadway traffic) is greater than or equal to supply (optimum roadway capacity at a given time). It can also be defined from the Highway Capacity Manual (HCM) as “the difference between the highway performance experienced by the users and how the system actually performs.” Traffic congestion typically entails periods of decreased or nonuniform travel speed, increased vehicle density, increased delays or travel times, and long queue lengths. Severe congestion known as “unacceptable congestion” consists of delays in excess of the acceptable/agreed-upon norms after accounting for the time of day, geographic location, mode of travel, and type of transportation facility. Congestion can also be further divided into recurring and non-recurring. Recurring congestion takes place at a specific time period every day and is usually associated with peak commute hours. Non-recurring congestion, on the other hand, could be a result of incidents, weather, lane closures, and other unforeseen capacity reductions or increase in traffic demand (i.e., special events).

Traffic congestion leads to significant direct (e.g., increased travel time and fuel consumption, wage loss) and indirect consequences (e.g., decreased safety, high environmental pollution). The negative safety and economic impacts resulting from traffic congestion can occur on any roadway at any moment. Although several techniques (e.g., proactive approaches) exist to establish varying congestion states, they are susceptible to inaccuracies. Prior techniques do not try to sufficiently distinguish between recurring and non-recurring congestion. In addition, prior techniques used to predict the onset of congestion are typically condition- or facility-specific or require excessive intermediate analysis and calibration.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In accordance with an embodiment, a method for traffic congestion detection for a roadway facility having a plurality of segments includes receiving travel time data from at least one travel time data source for a plurality of predetermined time intervals and determining a travel time index (TTI) for each time interval based on the travel time data associated with the time interval. The method further includes determining a change in travel time index (TTI) intensity between two successive time intervals for each pair of successive time intervals in the plurality of time intervals, applying a signal processing filter to the determined change in travel time index intensity to generate a filter value for each time interval; and determining a congestion level for each time interval based on the filter value for each time interval and a predetermined set of congestion level thresholds.

In accordance with another embodiment, a system for traffic congestion detection for a roadway facility having a plurality of segments includes an input for receiving travel time data from at least one travel time data source for a plurality of predetermined time intervals, and a traffic congestion detection module coupled to the input and configured to determine a congestion level for each time interval using the received travel time data, a determined change in a travel time index (TTI) intensity between two successive time intervals for each pair of successive time intervals in the plurality of time intervals, and a signal processing filter.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a block diagram of a system for traffic congestion detection in accordance with an embodiment;

FIG. 2 illustrates a method for traffic congestion detection in accordance with an embodiment;

FIG. 3 illustrates a method for determining thresholds for a set of traffic congestion levels in accordance with an embodiment;

FIG. 4 illustrates a method for traffic congestion management in accordance with an embodiment; and

FIG. 5 is a block diagram of an example computer system in accordance with an embodiment.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, those skilled in the art will readily recognize that these concepts may be practiced without these specific details. In some instances, this description provides well known structures and components in block diagram form in order to avoid obscuring such concepts.

While this description describes aspects and embodiments by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments.

In the following paragraphs, the embodiments are described in further detail by way of example with reference to the attached drawings. In the description, well known components, methods, and/or processing techniques are omitted or briefly described so as not to obscure the embodiments. As used herein, the “present disclosure” refers to any one of the embodiments described herein and any equivalents. Furthermore, reference to various feature(s) of the “present embodiment” is not to suggest that all embodiments must include the referenced feature(s).

Among embodiments, some aspects of the present disclosure are implemented by a computer program executed by one or more processors, as described and illustrated. As would be apparent to one having ordinary skill in the art, one or more embodiments may be implemented, at least in part, by computer-readable instructions in various forms, and the present disclosure is not intended to be limiting to a particular set or sequence of instructions executed by the processor.

The embodiments described herein are not limited in application to the details set forth in the following description or illustrated in the drawings. The disclosed subject matter is capable of other embodiments and of being practiced or carried out in various ways. Also, the phraseology and terminology used herein is for the purpose of description and should not be regarded as limiting. The use of “including,” “comprising,” or “having” and variations thereof herein is meant to encompass the items listed thereafter, additional items, and equivalents thereof. The terms “connected” and “coupled” are used broadly and encompass both direct and indirect connections and couplings. In addition, the terms “connected” and “coupled” are not limited to electrical, physical, or mechanical connections or couplings. As used herein, the terms “machine,” computer,” and “server” are not limited to a device with a single processor, but may encompass multiple devices (e.g., computers) linked in a system, devices with multiple processors, special purpose devices, devices with various peripherals and input and output devices, software acting as a computer or server, and combinations of the above.

As used herein, a roadway facility may be defined as a portion of a roadway (e.g., a freeway or expressway) with a plurality of segments selected for analysis. A segment of the roadway facility may be defined as a portion of the facility consisting of consistent geometric traffic properties (e.g., number of lanes, Annual Average Daily Traffic (AADTs), speed limits). A section of the roadway facility may be defined as smaller portions than segments, established to determine travel times (TTs) between two points. Travel Time (TT) may be defined as the time taken to traverse a section of roadway and the Travel Time Index (TTI) may be defined as the ratio of the actual TT to the ideal TT at free-flow speed (FFS).

The present disclosure describes a system and method for traffic congestion detection for a roadway facility having a plurality of segments. The system and method for traffic congestion detection may be configured to analyze real-time or near real-time travel time data to detect and proactively predict traffic congestion for one or more segments of a roadway facility and determine a congestion level (or congestion intensity level). In some embodiments, the determined congestion level for segments of a facility may be used to facilitate congestion management including, for example, the selection and timely deployment of mitigation strategies to alleviate the intensity of congestion. In some embodiments, the real-time or near real time travel time data may be provided by a travel time data source at predetermined time intervals (e.g., five minute intervals). The travel time data source may be a traditional travel time data source (e.g., radar, loop detectors, Bluetooth, probe vehicles, etc.) or a connected vehicle (CV)-based data source (e.g., CV generated basic safety messages (BSMs). Advantageously, the traffic congestion detections system and methods may be configured to distinguish between a plurality of predetermined congestion levels independent of the type of travel time data source providing the travel time data. Accordingly, the traffic congestion detection system and method may be applied to any data source with travel time estimates. The traffic congestion detection system and method can advantageously be deployed or utilized, for example, by transportation agency or department with access to real-time or near real-time travel time data and estimates. In some embodiments, the plurality of congestion levels include both recutting and non-recurring types of congestion. Recurring congestion takes place at a specific time period every day and is usually associated with peak commutes hours. Non-recurring congestion may be the results of incidents, weather, lane closures, and other unforeseen capacity reductions or increase in traffic demand (i.e., special events). In some embodiments, the plurality of congestion levels can include normal congestion, recurring or weather, other non-recurring congestion (including planned road closures), and incident. Accordingly, the traffic congestion detection system can be used to predict the onset of congestion and the intensity level of the congestion.

In some embodiments, the traffic congestion detection systems and methods may be configured to determine a congestion level for the roadway facility (e.g., segments or sections of the facility) from the real-time travel time data by using a signal processing filter and a set of predetermined thresholds associated with a plurality of congestion levels. In some embodiments, the signal processing filter is a Butterworth filter. In some embodiments, the travel time data received by the traffic congestion detections system from the travel time data source(s) can be used to determine a travel time index (TTI) for each time interval (e.g., five minute time intervals). The TTI for each time interval for a segment or section may then be used to compute a metric (b1) representing a change in TTI intensity between two successive time intervals (or time steps). The signal processing filter may then be applied to the b1 metrics for a series of time intervals (or time steps) to generate a filter value for each time (or time step). The filter value for each time (or time step) may then be compared to the predetermined congestion threshold values to identify a congestion level for each time step. By using data-driven and signal processing techniques coupled with real-time or near real-time measurements of travel time, the traffic congestion detection system can advantageously identify subtle factors that can precede impending congestion.

As mentioned, in some embodiments, each of the plurality of congestion levels may be associated with one or more thresholds. In some embodiments, the congestion thresholds may be determined using a historical database (or dataset) of travel time data (e.g., collected by transportation agencies or departments) and the signal processing filter. The historical database of travel time data. In some embodiments, the historical database (or dataset) of travel time data may include data from one or more geographic locations. In some embodiments, the historical dataset includes travel time data from a plurality of different sources including traditional travel time data sources and CV-based data sources. Data fusion may be used to combine information in the historical dataset of travel time data and to generate more complete datasets. Advantageously, in some embodiments, the newly generated travel time estimates (e.g., from the acquired real-time travel time data from the specific facility and location being analyzed with the traffic congestion detection system) and congestion levels determined by the traffic congestion detection system can be used to update the historical database of travel time data and to optimize the predetermined congestion levels and associated thresholds.

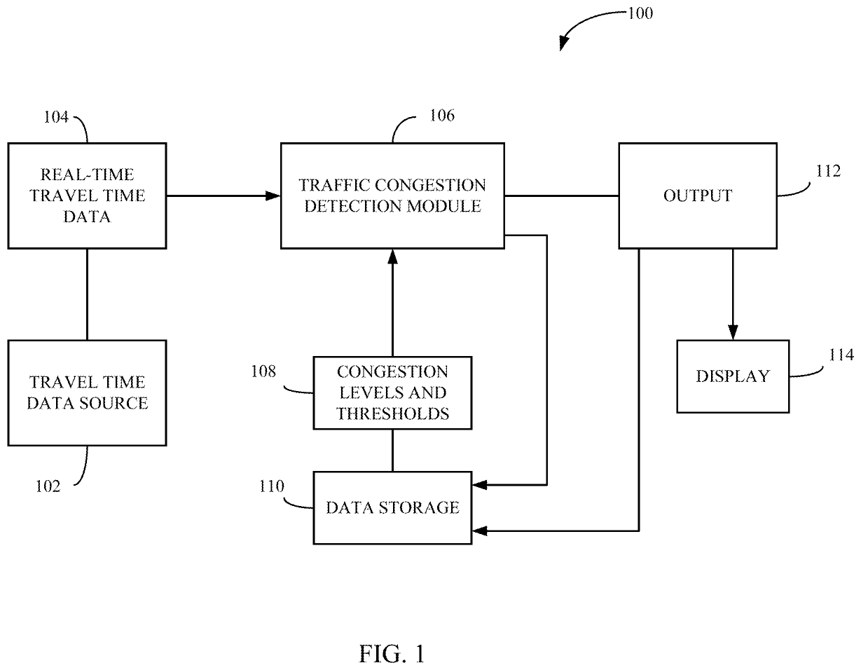

FIG. 1 is a block diagram of a system for traffic congestion detection in accordance with an embodiment. In FIG. 1, the system 100 can include one or more travel time data source(s) 102, an input of real-time travel time data 104, a traffic congestion detection module 106, congestion levels and thresholds 108, data storage 110, an output 112 of the traffic congestion detection module 106 and a display 114. In some embodiments, the real-time travel time data 104 may be received from the one or more travel time data source(s) 102. In some embodiments, the one or more travel time data sources 102 are configured to provide travel time data including data indicating travel time and other traffic-related data which can be used to determine or estimate travel time for a roadway facility including for segments or sections of the roadway facility. In some embodiments, the segments of the roadway facility are a predetermined length. In some embodiments the predetermined length of the segments may be based on, for example, agency specific precision requirements for identifying congestion location and progression for the agency collecting the travel time data 104 and conducting the analysis. In one example, the segments of the facility may be two miles or shorter in length.

In some embodiments, the travel time data sources(s) 102 can include, for example, traditional technologies and connected vehicle (CV) technologies. Traditional travel time data technologies can include, for example, cell phones, Bluetooth, loop detectors, video, radar detectors, RFID tags and readers, toll tags and electronic tolls, Global Positioning Systems (GPS), probe vehicles, social media reports, and weather APIs. CV-based technologies (or infrastructure) can utilize one or more of the following communications, for example, vehicle to vehicle (V2V), vehicle to infrastructure (V2I), infrastructure to vehicle (I2V), infrastructure to infrastructure (I2I), and vehicle to everything (V2X), to facilitate information transmission between roadway users and surrounding systems. Communications across these systems can be achieved via, for example, land mobile radios, commercial mobile radio services, radio frequency identifiers, infrared tags and beacons, WiFi, dedicated short range communications, cellular vehicle to everything (V2X), and Bluetooth. Connected vehicles (CVs) can be configured to generate Basic Safety Messages (BSMs) which can consist of information pertaining to, for example, the type, location, longitudinal/lateral control, and state of the CV. For example, CVs may be equipped with an on-board unit (OBU). Individual OBUs can be configured to broadcast BSMs continually to, for example, roadside units (RSUs) along the roadway. BSMs can be a primary source of CV data.

Real-time or near real-time travel time data 104 for a roadway facility may be collected or acquired using the travel time data sources 102 and provided as any input to the traffic congestion detection module 106. In some embodiments, the real-time travel time data 104 is collected from the travel time data source(s) 102 by, for example, a transportation agency or department for monitoring and managing traffic congestion for the roadway facility. The travel time data 104 may be collected and provided to the traffic congestion detection module 106 in real-time or near real-time. As used herein, the term “real-time” may refer to both real-time and near real-time. In some embodiments, the travel time data 104 may be acquired and provided as input to the traffic congestion detection module 106 at predetermined time intervals or time steps (e.g., five minute intervals). In some embodiments, the real-time travel time data 104 includes travel times or other traffic-related data (e.g., BSMs) that may be used to estimate or measure travel times. In some embodiments, travel time estimates may be acquired or determined for each section of the roadway facility at each time interval (e.g., a five minute time interval) for data acquisition. In some embodiments, a predetermined amount of real-time travel time data 104 at the predetermined time intervals for a given day may be collected before utilizing the traffic congestion detection module 106. In some embodiments, on each day, an initial set of real-time travel time data 104 may be acquired during a warm up time to provide sufficient time for initial data accumulation before the traffic congestion detection module 106 is used to generate predictions. For example, two hours (e.g., 24 of 5 minute time intervals or steps) of travel time data 104 may be acquired during a time frame such as, for example, 12 AM to 2 AM each day.

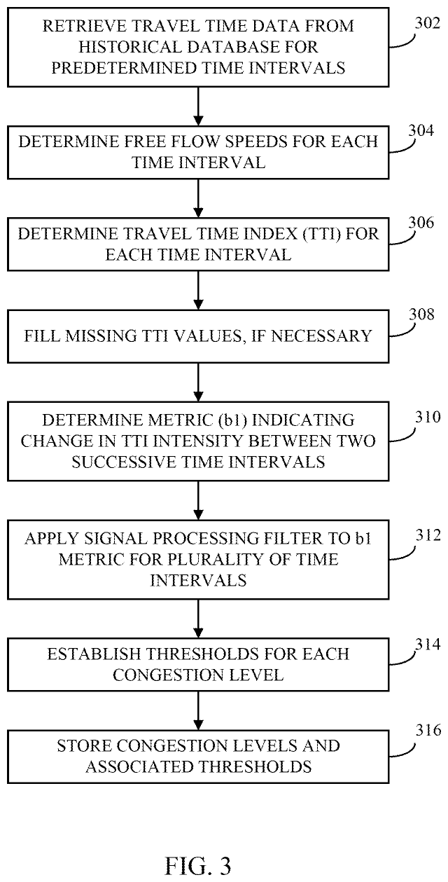

The traffic congestion detection module 106 may be configured to proactively detect congestion of the roadway facility and generate a prediction of congestion level or intensity. In some embodiments, the traffic congestion detection module 106 may analyze the travel time data 104 to detect congestion and determine a congestion level in real time or near real time. The traffic congestion detection module 106 may be configured to process the travel time data 104 in the predetermine time intervals. In some embodiments, the traffic congestion detection module is configured to determine a travel time index (TTI) value for each time interval (or time step). The travel time index may be determined as the ratio of the actual travel time to the ideal travel time at a free flow speed. A change in TTI intensity between two successive time steps may then be determined and in the present disclosure is represented as a universal metric, b1, given by:

$$b 1 = \frac{{TTI}_{t} - {TTI}_{t - 1}}{{TTI}_{t - 1}} \qquad ( 1 )$$

where, TTIₜ=TTI at time step t, and TTIₜ₋₁=TTI at the immediate previous time step. For example, in an embodiment where the time interval is 5 minutes, TTIₜ₋₁ would be the TTI at the immediately preceding time step 5 minutes prior to time step t. The b1 metric (Equation 1) may be used to unify the TTI distributions and high variability between time points. The change in TTI intensity, i.e., the b1 metric, advantageously also allows for the direct comparison between distinct segments in order to establish static zones of various types of congestion (e.g. congestion level thresholds), as discussed further below with respect to FIG. 3.

The traffic congestion detection modules is also configured to apply a signal processing filter to the determined b1 values for a series of time steps to generate a predicted value, also referred to herein as a filter value, for each time interval. In some embodiments, the signal processing filter may be applied to a predetermined number of the prior time steps or points. For example, the signal processing filter may be applied to the last 10 time points. In some embodiments, the signal processing filter is a Butterworth filter. A Butterworth filter is an infinite impulse response (IIR) filter that is designed to have a frequency response that is a flat as possible in the passband and is efficient at rejecting unwanted frequencies (low ripples in the processed signal) while maintaining uniform sensitivity towards the key frequencies. In some embodiments, a Butterworth filter may be given by:

$${H}_{( j ω )} = \frac{1}{\sqrt{1 + {( \frac{ω}{{ω}_{c}} )}^{2 n}}} \qquad ( 2 )$$

where, H=frequency response of the transfer function; n=filter order, i.e., the number of contributing elements within the transfer function; ω=angular frequency; and ω_{c}=cut-off frequency (frequency range that may be accepted and not considered noise). The filter may be used to smooth the high spikes followed by steep lows in the b1 metric while generating a more visualizable sine wave. In some embodiments, the traffic congestion detection module 106 may implement a second order Butterworth IIR filter with a bandpass ranging between 0 to 0.1 (0% to 10% change in b1) to capture changes in congestion. In this embodiment, a bandpass ranging from 0 to 0.1 may ensure that large highs followed by steep lows in the b1 metric may be minimized without affecting the overall observed trend. For congestion prediction, the negative b1 values may be treated as noise and filtered accordingly. In some embodiments, a second order Butterworth filter may minimize the negative b1 values (which consist of TTIs lower than free flow TTI that are may not be relevant for congestion detection) and may provide an early indication, from the wave maxima derived from consecutive spikes and dips in the b1 metric of potential or on-going congestion. As discussed above, in some embodiments, an initial predetermined amount of real-time travel time data 104 at the predetermined time intervals for a given day may be collected before utilizing the traffic congestion detection module 106. For example, two hours (e.g., 24 of 5 minute time intervals or steps) of travel time data 104 may be acquired during a time frame such as, for example, 12 AM to 2 AM each day.

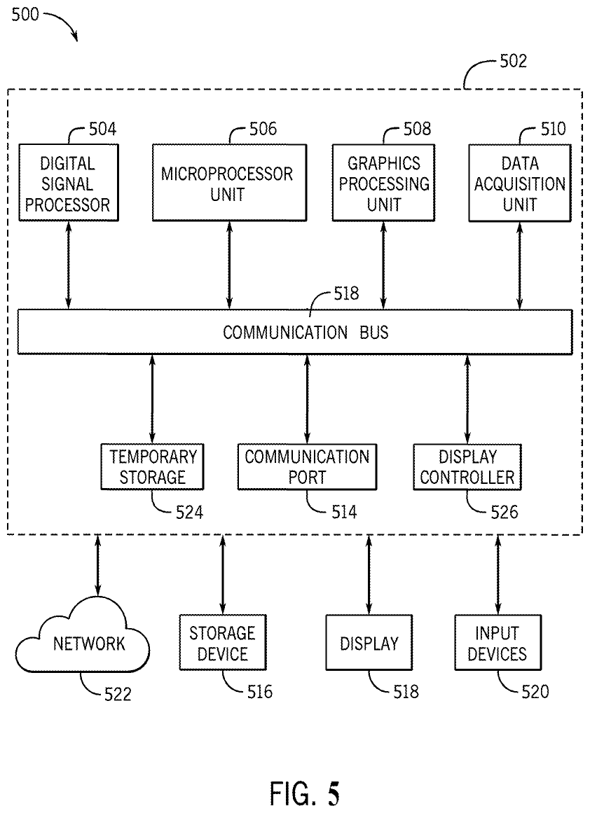

In some embodiments, once the predicted values (or filter values) have been generated by the signal processing filter of the traffic congestion detection module 106 for a series of time point, the predicted (or filter) values may be compared to predetermined congestion levels and associated thresholds 108 to identify and assign a congestion level for each time interval. The predetermined congestion levels and thresholds 108 may be stored in data storage 110 and retrieved by the traffic congestion detection module 106. In some embodiments, the plurality of congestion levels can include both recutting and non-recurring types of congestion. In some embodiments, the plurality of congestion levels can include normal congestion, recurring or weather-related, other non-recurring congestion (including planned road closures), and incident. A method for determining congestion level thresholds 108 is discussed further below with respect to FIG. 3. The traffic congestion detection module 106 may be configured to generate an output(s) 112 based on the analysis of the travel time data 104. In some embodiments, the output(s) 112 may include, for example, the assigned congestion (or intensity) level for each time interval, the b1 values for each time interval, a visualization of b1 values for a plurality of time points, etc. The output(s) 112 may be displayed on a display 114 (e.g., display 518 of the computer system 500 shown in FIG. 5). The output(s) 112 may also be stored in data storage, for example, data storage 110 (e.g., device storage 516 of computer system 500 shown in FIG. 5).

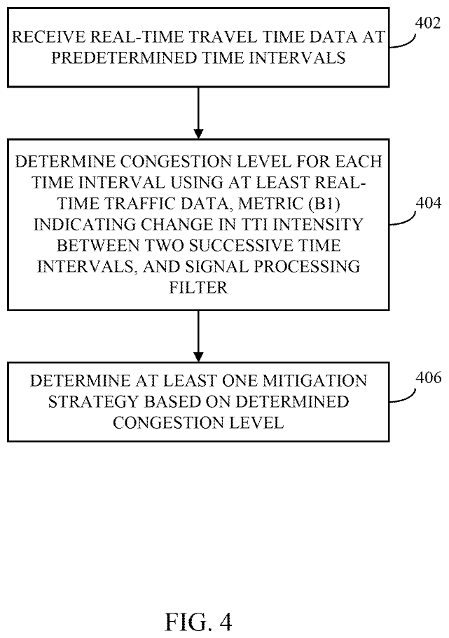

In some embodiments, the determined congestion levels may be used for used to facilitate congestion management including, for example, the selection and timely deployment of mitigation strategies, as discussed further below with respect to FIG. 4. In some embodiments, the newly generated travel time estimates (e.g., from the acquired real-time travel time data from the specific facility and location being analyzed with the traffic congestion detection module 106) and congestion levels determined by the traffic congestion detection module 106 can be used to update a historical database of travel time data and to optimize the predetermined congestion levels and associated thresholds 108. As mentioned above, a historical database (or dataset) of travel time data (e.g., collected by transportation agencies or departments) and the signal processing filter may be used to determine the congestion level thresholds, as discussed further below with respect to FIG. 3. In some embodiments, the historical database (or dataset) of travel time data may include data from one or more geographic locations.

In some embodiments, the traffic congestion detection module 106, the real-time data 104, the data storage 110, the congestion levels and thresholds 108, and the output 112 may be implemented and stored on one or more processors (or processor devices) of a computer system such as, for example, any general purpose computing system r device such as a personal computer, workstation, cellular phone, smartphone, laptop, tablet, or the like. As such, the computer system may include any suitable hardware and components designed or capable of carrying out a variety of processing and control tasks, including, but not limited to, receiving real-time traffic data 104, implementing the traffic congestion detection module 106, retrieving congestion levels 108 from data storage 110, providing the output 112 of the traffic congestion detection module 106 to a display 114 or storing the output 112 in data storage 110. For example, the computer system may include a programmable processor or combination of programmable processors, such as central processing units (CPUs), graphics processing units (GPUs), and the like. In some implementations, the one or more processors may be configured to execute instructions stored in a non-transitory computer readable media. In this regard, the computer system may be any device or system designed to integrate a variety of software, hardware, capabilities and functionalities. Alternatively, and by way of particular configurations and programming, the computer system may be a special purpose system or device. For instance, such special-purpose system or device may include one or more dedicated processing units or modules that may be configured (e.g., hardwired, or pre-programmed) to carry out steps in accordance with aspects of the present disclosure. In some embodiments, the traffic congestion detection module 106, data storage 110, output 112 and display 114 may be implemented as part of a roadside traffic monitoring system or in a computer system for a local transportation department or agency.

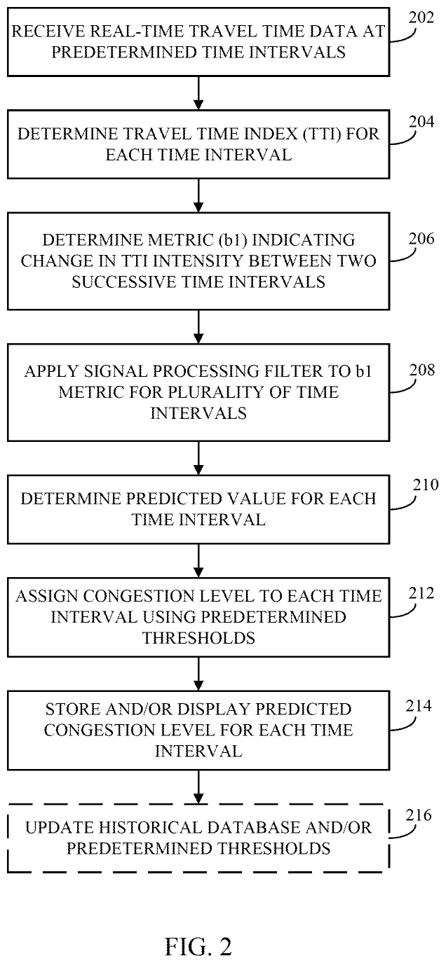

FIG. 2 illustrates a method for traffic congestion detection in accordance with an embodiment. The process illustrated in FIG. 2 is described below as being carried out by the system for traffic congestion detection as illustrated in FIG. 1. Although the blocks of the process are illustrated in a particular order, in some embodiments, one or more blocks may be executed in a different order than illustrated in FIG. 2, or may be bypassed.

At block 202, real-time (or near real-time) travel time data 104 is received by the traffic congestion detection module 106. In some embodiments, the real-time travel time data 104 may be received from the one or more travel time data source(s) 102. In some embodiments, the travel time data 104 may be acquired and provided as input to the traffic congestion detection module 106 at predetermined time intervals or time steps (e.g., five minute intervals). In some embodiments, the travel time data 104 can include data indicating travel time and other traffic-related data which can be used to determine or estimate travel time for a roadway facility including for segments or sections of the roadway facility. In some embodiments, the travel time data sources(s) 102 that provide the travel time data 104 can include, for example, traditional technologies and connected vehicle (CV) technologies. Traditional travel time data technologies can include, for example, cell phones, Bluetooth, loop detectors, video, radar detectors, RFID tags and readers, toll tags and electronic tolls, Global Positioning Systems (GPS), probe vehicles, social media reports, and weather APIs. CV-based technologies (or infrastructure) can utilize one or more of the following communications, for example, vehicle to vehicle (V2V), vehicle to infrastructure (V2I), infrastructure to vehicle (I2V), infrastructure to infrastructure (I2I), and vehicle to everything (V2X), to facilitate information transmission between roadway users and surrounding systems. Communications across these systems can be achieved via, for example, land mobile radios, commercial mobile radio services, radio frequency identifiers, infrared tags and beacons, WiFi, dedicated short range communications, cellular vehicle to everything (V2X), and Bluetooth. Connected vehicles (CVs) can be configured to generate Basic Safety Messages (BSMs) which can consist of information pertaining to, for example, the type, location, longitudinal/lateral control, and state of the CV. For example, CVs may be equipped with an on-board unit (OBU). Individual OBUs can be configured to broadcast BSMs continually to, for example, roadside units (RSUs) along the roadway. BSMs can be a primary source of CV data.

At block 204, the traffic congestion detection module 106 may determine a travel time index (TTI) value for each time interval (or time step). At block 206, a change in TTI intensity between two successive time steps may then be determined using the traffic congestion detection module 106. In the present disclosure the change in TTI intensity is represented as a universal metric, b1, given by Equation 1 above. At block 208, the traffic congestion detection module 106 can apply a signal processing filter to the determined b1 values for a series of time steps to generate a predicted value (or filter value) for each time interval at block 210. In some embodiments, the signal processing filter may be a Butterworth filter as given by Equation 2 above.

At block 212, the predicted (or filter) values may be compared to predetermined congestion levels and associated thresholds 108 using the traffic congestion detection module 106 to identify and assign a congestion level for each time interval. The predetermined congestion levels and thresholds 108 may be stored in data storage 110 and retrieved by the traffic congestion detection module 106. In some embodiments, the plurality of congestion levels can include both recutting and non-recurring types of congestion. In some embodiments, the plurality of congestion levels can include normal congestion, recurring or weather-related, other non-recurring congestion (including planned road closures), and incident

At block 214, the predicted congestion level for each time interval may be displayed on a display 114 (e.g., display 518 of the computer system 500 shown in FIG. 5). The predicted congestion level for each time interval may also be stored in data storage, for example, data storage 110 (e.g., device storage 516 of computer system 500 shown in FIG. 5). In some embodiments, optionally, at block 216 the newly generated travel time estimates (e.g., from the acquired real-time travel time data from the specific facility and location being analyzed with the traffic congestion detection module 106) and congestion levels determined by the traffic congestion detection module 106 at block 212 can be used to update a historical database of travel time data and to optimize the predetermined congestion levels and associated thresholds 108. As discussed further below with respect to FIG. 3, a historical database (or dataset) of travel time data may be used to generated the predetermined congestion level thresholds 108. In some embodiments, the historical dataset of travel time data may include data from one or more geographic locations.

FIG. 3 illustrates a method for determining thresholds for a set of traffic congestion levels in accordance with an embodiment. Although the blocks of the process are illustrated in a particular order, in some embodiments, one or more blocks may be executed in a different order than illustrated in FIG. 3, or may be bypassed.

At block 302, travel time data is retrieved from a historical database of travel time data. The historical database of travel time data may be stored in data storage of the traffic congestion detection system 100 (shown in FIG. 1) or may be stored in other data storage, for example, of other computer systems. In some embodiments, the travel time data is retrieved for a predetermined time interval or time step (e.g., a 5 minute time interval). The travel time data can include, for example, data indicating travel time and other traffic-related data which can be used to determine or estimate travel time for a roadway facility including for segments or sections of the roadway facility. In some embodiments, the historical dataset of travel time data may include data from one or more geographic locations. In some embodiments, the historical dataset includes travel time data from a plurality of different sources including traditional travel time data sources and CV-based data sources. Data fusion may be used to combine information in the historical dataset of travel time data and to generate more complete datasets. In some embodiments, data fusion may be used on the historical database of travel time data to produce a complex dataset consisting of various segment-specific traffic-related variables. At block 304, a free flow speed (FFS) for each time interval may be determined. In some embodiments, the free flow speed may be the 85th percentile speed determined using average speeds from, for example, 10 PM to 5 AM. At block 306, a travel time index (TTI) for each time interval is determined. The travel time index may be determined as the ratio of the actual travel time to the ideal travel time at the free flow speed.

At block 308, if necessary, missing TTI values may be filled in, for example, by using the TTI value from the last known time interval. In some embodiments, TTI values may be missing because certain time intervals have no recorded travel time estimates. At block 310, a change in TTI intensity between two successive time steps may then be determined using the traffic congestion detection module 106. In the present disclosure the change in TTI intensity is represented as a universal metric, b1, given by Equation 1 above. As mentioned above, the change in TTI intensity, i.e., the b1 metric, advantageously allows for the direct comparison between distinct segments in order to establish static zones (i.e., defined by static thresholds) of various types of congestion (e.g. congestion level thresholds. Advantageously, the density plots of the b1 metric may be more normally distributed around a common mean than the density plots of TTI. Without the b1 metric, individual thresholds for congestion levels would need to be developed for each segment. However, use of the b1 metric allows thresholds for congestion levels to be established that are generally applicable to any segment. Accordingly, the b1 metric provides a universal approach to setting status thresholds for each congestion level.

At block 312, a signal processing filter may be applied to the determined b1 values for a series of time steps to generate a predicted value (or filter value) for each time interval. In some embodiments, the signal processing filter may be a Butterworth filter as given by Equation 2 above. The filter may be used to smooth the high spikes followed by steep lows in the b1 metric while generating a more visualizable sine wave. In some embodiments, a second order Butterworth IIR filter with a bandpass ranging between 0 to 0.1 (0% to 10% change in b1) may be used to capture changes in congestion. In this embodiment, a bandpass ranging from 0 to 0.1 may ensure that large highs followed by steep lows in the b1 metric may be minimized without affecting the overall observed trend. For congestion prediction, the negative b1 values may be treated as noise and filtered accordingly. In some embodiments, a second order Butterworth filter may minimize the negative b1 values (which consist of TTIs lower than free flow TTI that are may not be relevant for congestion detection) and may provide an early indication, from the wave maxima derived from consecutive spikes and dips in the b1 metric of potential or on-going congestion. In some embodiments, an initial predetermined amount of historical travel time data at the predetermined time intervals may be provided to the signal processing filter to be processed prior to generating predictions. For example, two hours (e.g., 24 of 5 minute time intervals or steps) of travel time data may be processed from a time frame such as, for example, 12 AM to 2 AM.

At block 314, thresholds for each congestion level (e.g., for various types of congestion) may be established. In some embodiments, the thresholds may be established based on the output (i.e. filter value) of the signal processing filter (e.g., a Butterworth filter) for ach time interval at block 312 and the traffic-related data from the historical database associated with the time interval or time step for each filter value. The differences in the filter values for each congestion types may be compared by determining a cumulative density function (CDF) and quantiles for each type of congestion. In some embodiments, the types of congestion selected for the congestion level may be determined by tracking common causes of congestion within the combined (i.e., fused) historical database of travel time data, for example, normal, recurring, weather, road closures, and incidents. In some embodiments, normal conditions may be established for the filter output (i.e., filter values) by filtering out filter values for time periods that consisted of any indication of adverse conditions such as incidents, road closures, and weather, and excluding public holidays which typically show non-recurring congestion patterns. In some embodiments, normal condition may be assumed to occur after 10 PM and before 5 AM of any given day. In some embodiments, recurring congestion may be established for the filter output (i.e., filter values) by also isolating (or filtering out) adverse conditions and public holidays. In some embodiments, the recurring conditions may be assumed to occur from 5 AM to 10 PM on any given day in order to generalize hours of daily recurring congestion and to, for example, account for high variability of recurring periods within/between segments and day of week. In some embodiments, weather-related congestion may be established for the filter output (i.e., filter values) by assessing congestion peaks in the fused historical database travel time data associated with the time intervals for each filter value. In some embodiments, the two main weather-related variables contributing to congestion may be precipitation and visibility. For example, higher congestion may occur if precipitation was present and visibility was less than 4 miles. In some embodiments, as adverse weather during late night/early hours may not significantly affect traffic flow due to inherently low volumes, travel time data from 5 AM to 10 PM may be used to determine the filter value thresholds for weather-related congestion. In some embodiments, incident and road closure-related congestion may be established for the filter output (i.e., filter values) by assessing the historical time travel data from 5 AM to 10 PM to identify time intervals and filter values associated with incidents and road-closures. In some embodiments, the 95th percentiles filter output values for each congestion type may be selected as the thresholds for the congestion type. In one example, four congestion levels may be used, namely, normal, recurring or weather related, other non-recurring, and incident. In this example, certain congestion types (e.g., the recurring and weather-related congestion) may be combined in one congestion level if they demonstrate identical trends which indicates similar intensities for both congestion types. In an example, the filter value (y) thresholds for each congestion level can be: 1) Normal congestion (Level 1): y≤0.030; 2) Recurring or Weather (Level 2): 0.030<y≤0.048; 3) Other Non-recurring (Level 3): 0.048<y≤0.170; and 4) Incident (Level 4): y>0.170. In other examples, more or less than four congestion levels and the thresholds for each congestion level may be established from the historical travel time data using the b1 metric and the signal processing filter.

At block 316, the congestion levels and associated thresholds determined at block 318 may be stored in in data storage, for example, data storage 110 (e.g., device storage 516 of computer system 500 shown in FIG. 5).

As mentioned above with respect to FIGS. 1 and 2, in some embodiments the congestion levels determined by the traffic congestion detection module 106 may be used for used to facilitate congestion management including, for example, the selection and timely deployment of mitigation strategies. FIG. 4 illustrates a method for traffic congestion management in accordance with an embodiment. The process illustrated in FIG. 4 is described below as being carried out by the system for traffic congestion detection as illustrated in FIG. 1. Although the blocks of the process are illustrated in a particular order, in some embodiments, one or more blocks may be executed in a different order than illustrated in FIG. 4, or may be bypassed.

At block 402, real-time (or near real-time) travel time data 104 is received by the traffic congestion detection module 106. In some embodiments, the real-time travel time data 104 may be received from the one or more travel time data source(s) 102. In some embodiments, the travel time data 104 may be acquired and provided as input to the traffic congestion detection module 106 at predetermined time intervals or time steps (e.g., five minute intervals). In some embodiments, the travel time data 104 can include data indicating travel time and other traffic-related data which can be used to determine or estimate travel time for a roadway facility including for segments or sections of the roadway facility. In some embodiments, the travel time data sources(s) 102 that provide the travel time data 104 can include, for example, traditional technologies and connected vehicle (CV) technologies.

At block 404, a congestion level for each time interval may be determine using the traffic congestion detection module 106. As discussed above with respect to FIGS. 1 and 2, the congestion level for each time interval may be predicted by processing the real-time travel time data using a metric (b1, Equation 1) indicating a change in TTI intensity between two successive time intervals and a signal processing filter. At block 406, at least one mitigation strategy may be determined based on the determined congestion levels at block 404. In some embodiments, the at least one mitigation strategy may be determined automatically by the traffic congestion detection system 100 (e.g., by the traffic congestion detection module 106), for example, the selection of a mitigation strategy may be triggered by the determined congestion levels. In some embodiments, the congestion levels determined at block 404 may be presented to a user on a display 114 along with one or more recommended mitigation strategies generated based on the determine congestion levels. The user may then implement one of the recommended mitigation strategies. In some embodiments, the one or more mitigation strategies identified by the traffic congestion detection system 100 may be implemented automatically. The mitigation strategies can include, for example, speed harmonization, dynamic rerouting, ramp metering, combinations thereof, etc.

FIG. 5 is a block diagram of an example computer system in accordance with an embodiment. Computer system 500 may be used to implement the systems and methods described herein. In some embodiments, the computer system 500 may be an on-board vehicle computer system, an off-board computer system external (or off-board) to one more vehicles in traffic (e.g., as part of a roadside traffic monitoring system), a workstation, a notebook computer, a tablet device, a mobile device, a multimedia device, a network server, a mainframe, one or more controllers, one or more microcontrollers, or any other general-purpose or application-specific computing device. The computer system 500 may operate autonomously or semi-autonomously, or may read executable software instructions from the memory or storage device 516 or a computer-readable medium (e.g., a hard drive, a CD-ROM, flash memory), or may receive instructions via the input device 520 from a user, or any other source logically connected to a computer or device, such as another networked computer or server. Thus, in some embodiments, the computer system 500 can also include any suitable device for reading computer-readable storage media.

Data, such as data acquired with, for example, one or more sensors (e.g., on-board vehicle sensors or roadside sensors), may be provided to the computer system 500 from a data storage device 516, and these data are received in a processing unit 502. In some embodiments, the processing unit 502 included one or more processors. For example, the processing unit 502 may include one or more of a digital signal processor (DSP) 504, a microprocessor unit (MPU) 506, and a graphic processing unit (GPU) 508. The processing unit 502 also includes a data acquisition unit 510 that is configured to electronically receive data to be processed. The DSP 504, MPU 506, GPU 508, and data acquisition unit 510 are all coupled to a communication bus 512. The communication bus 512 may be, for example, a group of wires, or a hardware used for switching data between the peripherals or between any component in the processing unit 502.

The processing unit 502 may also include a communication port 514 in electronic communication with other devices, which may include a storage device 516, a display 518, and one or more input devices 520. Examples of an input device 520 include, but are not limited to, a keyboard, a mouse, and a touch screen through which a user can provide an input. The storage device 516 may be configured to store data, which may include data such as, for example, historical traffic data, real-time traffic data (e.g., travel time data), congestion level types and thresholds, predicted traffic congestion levels for one or more segments, selected mitigation strategies, etc., whether these data are provided to, or processed by, the processing unit 502. The display 518 may be used to display images and other information, such as patient health data, and so on.

The processing unit 502 can also be in electronic communication with a network 522 to transmit and receive data and other information. The communication port 514 can also be coupled to the processing unit 502 through a switched central resource, for example the communication bus 512. The processing unit 502 can also include temporary storage 524 and a display controller 526. The temporary storage 524 is configured to store temporary information. For example, the temporary storage can be a random access memory.

As those skilled in the art will readily appreciate, various aspects described throughout this disclosure may be extended to other systems, apparatuses, and modules.

The present disclosure uses the word “exemplary” to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The present disclosure uses the term “coupled” to refer to a direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The present disclosure uses the terms “circuit” and “circuitry” broadly, to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-5 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-5 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged.

What is claimed is:

1. A method for traffic congestion detection for a roadway facility having a plurality of segments, the method comprising:
receiving travel time data from at least one travel time data source for a plurality of predetermined time intervals;
determining a travel time index (TTI) for each time interval based on the travel time data associated with the time interval;
determining a change in travel time index (TTI) intensity between two successive time intervals for each pair of successive time intervals in the plurality of time intervals;
applying a signal processing filter to the determined change in travel time index intensity to generate a filter value for each time interval; and
determining a congestion level for each time interval based on the filter value for each time interval and a predetermined set of congestion level thresholds.

2. The method according to claim 1, wherein the at least one travel time data source is a connected-vehicle (CV)-based data source.

3. The method according to claim 1, wherein the change in travel time index (TTI) intensity between two successive time intervals is given by:
$$b 1 = \frac{{TTI}_{t} - {TTI}_{t - 1}}{{TTI}_{t - 1}}$$
where, b1 is the change in travel time intensity between two successive time intervals, TTIₜ is TTI at a time step t, and TTIₜ₋₁ is TTI at an immediately previous time step.

4. The method according to claim 1, wherein the signal processing filter is a Butterworth filter.

5. The method according to claim 4, wherein the Butterworth filter is given by:
$${H}_{( j ω )} = \frac{1}{\sqrt{1 + {( \frac{ω}{{ω}_{c}} )}^{2 n}}}$$
where, H is a frequency response of the transfer function, n is the filter order, ω is angular frequency; and ω_{c} is a cut-off frequency.

6. The method according to claim 1, wherein determining a congestion level for each time interval based on the filter value for each time interval and a predetermined set of congestion level thresholds comprises comparing the filter value for each time interval to the predestined set of congestion level thresholds.

7. The method according to claim 1, wherein the determined congestion level is one of normal, recurring, weather, road closure, or incident.

8. The method according to claim 1, wherein the predetermined set of congestion level thresholds is generated using a historical dataset of travel time data for a plurality of geographic locations.

9. The method according to claim 9, further comprising updating the historical dataset of travel time data and the predetermined congestion level thresholds based on the received travel time data and the determined congestion level for each time interval.

10. The method according to claim 1, further comprising determining a mitigation strategy based on the determined congestion level for each time interval.

11. The method according to claim 1, wherein the received travel time data is received from the at least one travel time data source in real-time.

12. A system for traffic congestion detection for a roadway facility having a plurality of segments, the system comprising:
an input for receiving travel time data from at least one travel time data source for a plurality of predetermined time intervals; and
a traffic congestion detection module coupled to the input and configured to determine a congestion level for each time interval using the received travel time data, a determined change in a travel time index (TTI) intensity between two successive time intervals for each pair of successive time intervals in the plurality of time intervals, and a signal processing filter.

13. The system according to claim 12, wherein the traffic congestion detection module is further configured to:
determine a travel time index (TTI) for each time interval based on the travel time data associated with the time interval;
determine the change in travel time index (TTI) intensity between two successive time intervals for each pair of successive time intervals in the plurality of time intervals;
apply the signal processing filter to the determined change in travel time index intensity to generate a filter value for each time interval; and
determine a congestion level for each time interval based on the filter value for each time interval and a predetermined set of congestion level thresholds.

14. The system according to claim 12, wherein the received travel time data is received from the at least one travel time data source in real-time.

15. The system according to claim 12, wherein the at least one travel time data source is a connected-vehicle (CV)-based data source.

16. The system according to claim 12, wherein the change in travel time index (TTI) intensity between two successive time intervals is given by:
$$b 1 = \frac{{TTI}_{t} - {TTI}_{t - 1}}{{TTI}_{t - 1}}$$
where, b1 is the change in travel time intensity between two successive time intervals, TTIₜ is TTI at a time step t, and TTIₜ₋₁ is TTI at an immediately previous time step.

17. The system according to claim 12, wherein the signal processing filter is a Butterworth filter.

18. The system according to claim 13, wherein determining a congestion level for each time interval based on the filter value for each time interval and a predetermined set of congestion level thresholds comprises comparing the filter value for each time interval to the predestined set of congestion level thresholds.

19. The system according to claim 13, wherein the predetermined set of congestion level thresholds is generated using a historical dataset of travel time data for a plurality of geographic locations.
